(19) United States
(12) Patent Application Publication
(10) Pub. No.: US 2012/0158684 A1
(43) Pub. Date: Jun. 21, 2012

(54) PERFORMANCE ENHANCED SYNCHRONIZATION MECHANISM WITH INTENSITY-ORIENTED READER API

(75) Inventors: Rafael Lowenstein, Nesher (IL); Roee Engelberg, Nesher (IL); Lev Vainblat, Kiriat Yam (IL)

(73) Assignee: LSI CORPORATION, Milpitas, CA (US)

(21) Appl. No.: 12/974,096

(22) Filed: Dec. 21, 2010

(51) Int. Cl. G06F 17/30

(52) U.S. Cl. 707/704; 707/E17.005

(57) ABSTRACT

A method for synchronizing data operations in a multi-threaded computer system using a hybrid lock data structure that allows the computer system to dynamically implement a low contention cost lock or a low overhead cost lock based on the intensity of the memory operation.

### FIELD OF THE INVENTION

The present invention relates to memory utilization in electrical computers and digital processing systems; and particularly to file management and data structure integrity using locks.

### BACKGROUND OF THE INVENTION

In multi-threaded environments, separate threads or execution threads or processes often access the same data set. To ensure data coherency and proper functioning in such environments, a computer system must limit and control access to the shared data with a synchronization mechanism. A common example of such a synchronization mechanism is a data lock. A data lock is a mechanism for enforcing limits on access to a resource in an environment with multiple execution threads.

A data lock API includes two main operations: an execution thread acquires a lock before the execution thread accesses the protected data; then the execution thread releases the lock once the execution thread has performed an operation on the data. In a simple lock, only one execution thread may hold the lock at a time.

In more complex schemes, a software developer may distinguish between execution threads that are accessing data in order to read it (readers) and execution threads that are accessing data in order to change it (writers); a locking scheme that makes such a distinction is commonly referred to as a readers-writer lock. In a readers-writer lock, several readers can gain access to the data protected by the lock at the same time, while a writer is owed access to the data only when no other execution thread accesses the data

There are different possible implementations of locks. Each implementation incurs some cost to performance and imposes some restrictions. Contention cost is the detrimental effect on performance of an execution thread when the execution thread has to wait for a lock that is taken by some other execution thread, plus all of the system resources consumed by any waiting processes while they wait. Contention cost also depends on the type of waiting; specifically, some types of locks cause threads to “busy-wait” consume high CPU resources and therefore have higher contention costs than other types of locks. Overhead cost is the detrimental effect on system performance due to the operations needed to acquire, release and manage the lock (usually by the operating system). Most locks incur either high contention cost or high overhead cost. Thus, a software developer has to choose a lock scheme, at the time of compilation, according to a predicted usage pattern of a potential execution thread.

A software developer may attempt to predict a certain piece of software's access pattern to a certain piece of data and implement a lock scheme accordingly; however, there are common cases when the access pattern for the protected data varies. That is, sometimes the same data is accessed for short read operations in some parts of the computer code and in other parts it is accessed for heavier read operations. In such cases, using locks with high contention cost is problematic because the lock may be held for a long time; using locks with high overhead cost is a compromise that incurs relatively high cost when the lock is acquired for a short time, especially if the data is accessed frequently and performance is important (e.g. real-time systems).

Consequently, it would be advantageous if a method and apparatus existed that were suitable for allowing an execution thread to specify the level of intensity of a data read, and thereby determine what type of lock the execution thread will acquire on data at the time of execution.

### SUMMARY OF THE INVENTION

Accordingly, the present invention is directed to a method and apparatus for allowing an execution thread to specify the level of intensity of a data read, and thereby determine what type of lock the execution thread will acquire on data, at the time of execution. The method may incorporate a hybrid lock data structure.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 depicts a data structure diagram showing a hybrid lock data structure and an associated intensity indication type;

FIG. 2 depicts a flow chart for implementing a hybrid lock data structure for various read and write operations;

FIG. 3 depicts a block diagram of a multi-threaded computer system configured to implement a hybrid data structure to perform the operations depicted in FIG. 2; and

FIG. 4 depicts a block diagram of a client-server computer system configured to implement a hybrid data structure to perform the operations depicted in FIG. 2.

### DETAILED DESCRIPTION OF THE INVENTION

The present invention relates to a method for implementing a data synchronization mechanism in a multi-threaded environment at the time of execution based on the intensity of a data read operation. Reference will now be made in detail to the subject matter disclosed, which is illustrated in the accompanying drawings.

In multi-threaded applications, each execution thread cooperates with the other execution threads by acquiring a lock before accessing corresponding data. Computer systems executing primarily frequent, short read operations use locks that have low overhead cost; computer systems that primarily execute heavy read operations use locks that have low contention cost. Contention cost and overhead cost are closely related to the concept of granularity. Granularity refers to the scope of a lock; a lock with coarse granularity covers a relatively large percentage of the corresponding data, such as an entire database or an entire table; while a lock with fine granularity covers a relatively small percentage of the corresponding data, such as a single row or a single cell in a database.

A lock scheme produces a high contention cost when the lock scheme prohibits access by other execution threads to a large amount of the corresponding data. Locks with high contention cost generally have coarse granularity because the scope of a lock with coarse granularity is so large that a second, independent execution thread is more likely to attempt to access some portion of the data protected by the lock; the second execution thread would be forced to wait for the first execution thread to release the lock. Performance lost by the second execution thread while waiting for the first execution thread to release the lock, and system resources consumed by the waiting execution thread while waiting are a measure of contention cost. Contention cost is a function of the number of waiting execution threads multiplied by the cost for each waiting execution thread. Locks with coarser granularity are likely to force a greater number of execution threads to wait than locks with finer granularity. Also, locks that cause execution threads to “busy-wait” impose a greater cost on each execution thread than locks than impose some other waiting scheme.

High contention cost lock schemes can lead to undesirable conditions such as deadlock (each execution thread waits for the other to release a lock), livelock (each execution thread continues to execute but neither can progress) and priority inversion (a high priority execution thread waits for a low priority execution thread to release a lock). These situations are especially detrimental to high priority or real-time execution threads.

A lock scheme produces a high overhead cost when the lock scheme does not prohibit access for read operations, or prohibits access to a very small portion of the corresponding data. Any lock scheme requires resources from the operating system to implement, monitor, maintain and update any locks in use. As the number of locks used by the lock scheme increases, the amount of resources required from the operating system also increases. Where a lock scheme has fine granularity, say at the level of a database row, the lock scheme may use a very large number of locks, perhaps one lock for each row of the database. The operating system resources used to implement, monitor and destroy each lock are a measure of overhead cost. Furthermore, different types of locks incur differing overhead costs. Locks invoking operating system level services incur greater cost because the operating system consumes additional CPU and memory resources managing data structures and tracking which execution threads to wake up. Even where a lock scheme does not prohibit access to the corresponding data for read operations, each execution thread performing a read operation must still acquire a lock to prevent the corresponding data from being overwritten during the read operation. Therefore, depending on the number of threads, a lock scheme with coarse granularity may still produce high overhead cost.

Write operations generally require an exclusive lock on the corresponding data. Write operations necessarily change the data on which the operation is performed; another thread simultaneously attempting to perform a read operation may receive corrupted data and behave unpredictably.

The present invention is directed toward implementations of a readers-writer lock scheme. A readers-writer lock is a synchronization mechanism that allows multiple execution threads to perform read operations simultaneously, but grants exclusive access to execution threads performing write operations. A lock scheme that grants access to multiple execution threads for read operations necessarily imposes greater overhead cost than a lock scheme that grants exclusive access to each execution thread because a lock scheme that grants exclusive access need only grant the lock to each execution thread as the lock is released by the previous execution thread; a lock scheme that grants access to multiple execution threads must have some mechanism for managing several thread simultaneously. Furthermore, a lock scheme that allows access to multiple execution threads also creates opportunities for contention between execution threads attempting to perform read operations and execution threads attempting to perform write operations. If data is controlled by a readers-writer lock that allows immediate access to all readers so long as the data is not subject to an exclusive lock, an execution thread attempting to perform a write operation may wait indefinitely for an exclusive lock while other execution threads perform read operations on the same data, provided the multiple read operations continue to overlap in time. To rectify this situation, a well designed readers-writer lock scheme requires functionality to queue and prioritize execution threads based on the intended operation, which adds additional overhead cost.

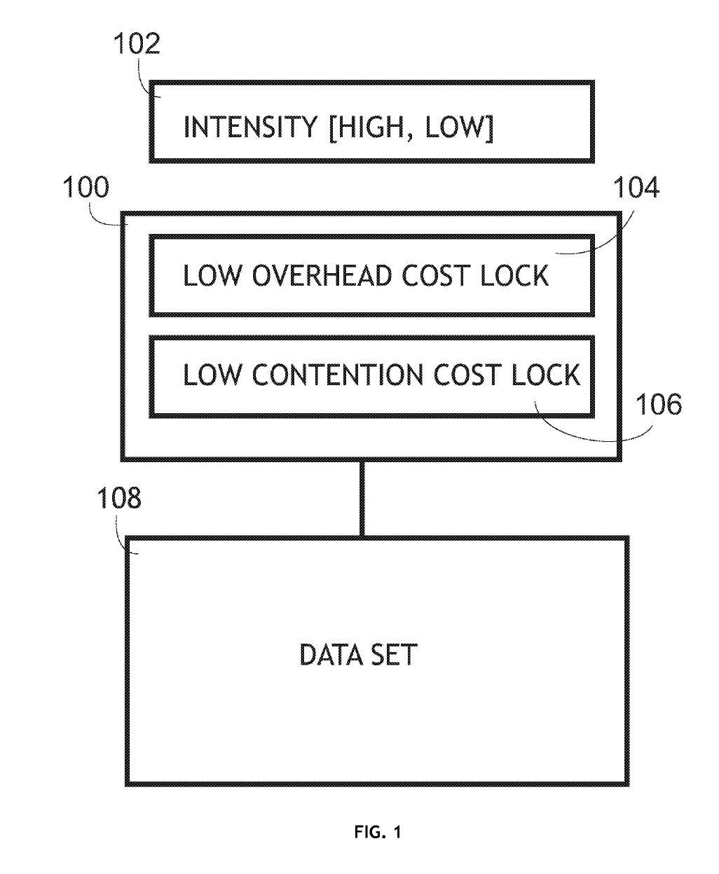

Referring to FIG. 1, a computer system may implement a hybrid lock data structure 100 having a mechanism to implement a lock with low overhead cost 104 such as a spinlock, and a mechanism to implement a lock with low contention cost 106 such as semaphores. Semaphores are data structures commonly used in parallel programming to control access to resources. In one implementation a resource is assigned a globally accessible variable (the semaphore) that contains the number of execution threads accessing the resource; the implementation contains methods to increment and decrement the semaphore as new execution threads request access and existing execution threads release access. A spinlock is a type of lock wherein an execution thread waits in a loop until the execution thread can acquire an exclusive lock on whatever data or resource the execution thread is attempting to access.

The hybrid lock data structure protects a predefined data set 108 such as a file, database, array, list or any other similar data structure, or some subset of such data structure. The hybrid lock data structure may be implemented with any degree of granularity; however, the hybrid lock data structure is intended to provide the benefits of both low overhead cost and low contention cost depending on the intensity of the read operation. A hybrid lock data structure with very fine granularity may not enjoy the benefits of low overhead cost because the number of locks necessary to protect an entire data set could be prohibitive; therefore, a well implemented hybrid lock will generally have coarser granularity than a well implemented lock scheme designed to provide exclusive access to each execution thread and low contention cost.

The hybrid lock data structure may incorporate a data type 102 to indicate the intensity of a read operation. In one embodiment, a data structure contains either an indication that a read operation is a heavy intensity read operation or a low intensity read operation based on the amount of data the operation intends to read. The hybrid lock data structure may also incorporate methods for acquiring and releasing various types of data locks. For example, a hybrid lock data structure may include methods to implement a spinlock wherein the hybrid lock data structure grants a first execution thread an exclusive lock on the corresponding data while placing all subsequent execution threads into a loop until the first execution thread releases the exclusive lock; the hybrid lock data structure may also include a data structure such as a queue to prioritize any execution threads in a spinlock. The hybrid lock data structure may implement semaphores wherein the hybrid lock data structure increments and decrements a semaphore based on each execution thread that requests and releases a lock on the corresponding data respectively. A hybrid lock data structure may handle and prioritizes execution threads attempting to perform read operations separately from execution threads attempting to perform write operations. A hybrid lock data structure may grant higher priority to execution threads attempting to perform write operations.

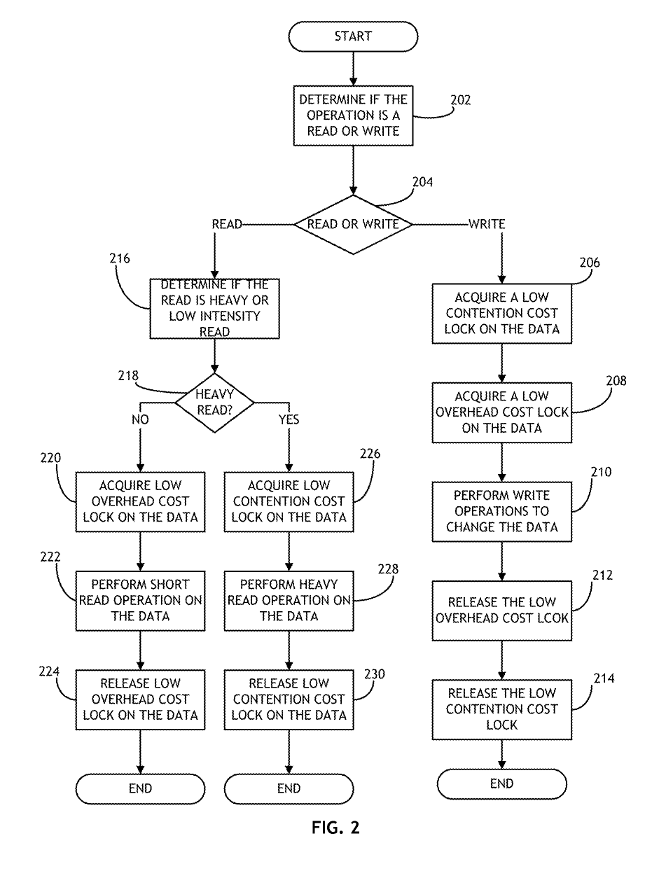

Referring to FIG. 2, a computer system executing computer code implementing one embodiment of the present method receives a request to access certain data which is subject to a hybrid lock data structure. The computer system determines if the requested access is for a read operation or a write operation 202. If the operation is a read operation, the computer system determines if the read operation is a heavy or low intensity read 216. Heavy and low intensity in this context are relative, and defined by overall system performance for various data locking strategies. A heavy intensity read operation is a read operation that imposes less of a burden on the overall performance of the computer system using a low contention cost lock, such as semaphores, rather than a low overhead cost lock, such as a spinlock. A low intensity read operation is a read operation that imposes less of a burden on the overall performance of the computer system using a low overhead cost lock, such as a spinlock, rather than a low contention cost lock, such as semaphores. For example, a read operation attempting to read an entire table from a database would be a heavy intensity read operation because a table is generally a substantial portion of an entire database with a correspondingly high probability that other execution threads will attempt to access the table during the read operation. Likewise, a read operation attempting to read a single row from a database would be a low intensity read operation because a row is generally a very small portion of an entire database with a correspondingly small probability that other execution threads will attempt to access the same row during the read operation. The cost incurred in any given situation may also be a function of the type of locks implemented; for example, a low contention cost lock implemented as an operating system level service may incur additional cost as compared to some other implementation, while a low overhead cost lock implemented using a “busy-wait” may incur additional cost as compared to some other waiting mechanism.

Where the read operation is a heavy intensity read operation, the computer system acquires a low contention cost lock on the data to be read 226. The computer system then performs the heavy read operation on the data 228 and releases the low contention cost lock 230. Low contention cost locks include non-exclusive locks implemented by semaphores.

Where the read operation is a low intensity read operation, the computer system acquires a low overhead cost lock on the data to be read 220. The computer system then performs the short read operation on the data 222 and releases the low overhead cost lock 224. Low overhead cost locks include exclusive locks such as spinlocks.

If an operation is a write operation, the computer system acquires a low contention cost lock on the data to be overwritten 206; then the computer system acquires a low overhead cost lock on the data to be overwritten 208. The order by which the computer system acquires data locks is important for system performance. Implementations of low contention cost locks have either fine granularity or non-exclusivity for read operations. Low contention cost locks with non-exclusivity must provide a mechanism for exclusive locking during write operations and often provide a mechanism for prioritizing write operations over read operations. Therefore, an execution thread attempting to perform a write operation on data controlled by a hybrid lock data structure would first attempt to acquire a low contention cost lock. Once the execution thread attempting to perform the write operation has acquired a low contention cost lock, the execution thread then acquires a low overhead cost lock on the data to ensure that no other execution thread can access the data to perform a read operation while the data is being overwritten. The execution thread attempting to perform the write operation first acquires a low contention cost lock to avoid incurring the cost associated with consuming system resources while waiting as described above. The computer system then performs the write operation 210, and releases the low overhead cost lock 212 and the low contention cost lock 214.

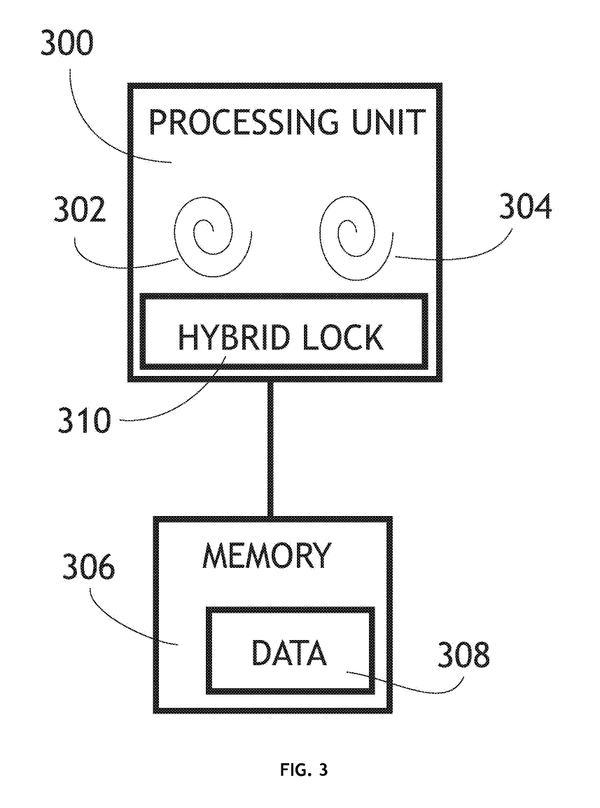

Referring to FIG. 3, an apparatus implementing the present method comprises at least one processing unit 300 operatively connected to memory 306 containing data 308 controlled by a hybrid lock data structure 310, and at least two execution threads 302 and 304 executing on the at least one processing unit. In this embodiment, computer executable code executing on the at least one processing unit 300 provides access to the data 308 stored in the memory 306. The computer executable code providing access to the data also limits access to the data in a-multi-threaded environment by means of a hybrid lock data structure 310. An execution thread 302 or 304 attempting to perform a read operation on the data 308 must provide an indication of the intensity of the intended read operation. Where the execution thread 302 or 304 indicates a heavy intensity read operation, the computer executable code grants the execution thread 302 or 304 a low contention cost lock through the hybrid lock data structure 310. Where the execution thread 302 or 304 indicates a low intensity read operation, the computer executable code grants the execution thread 302 or 304 a low overhead cost lock through the hybrid lock data structure 310.

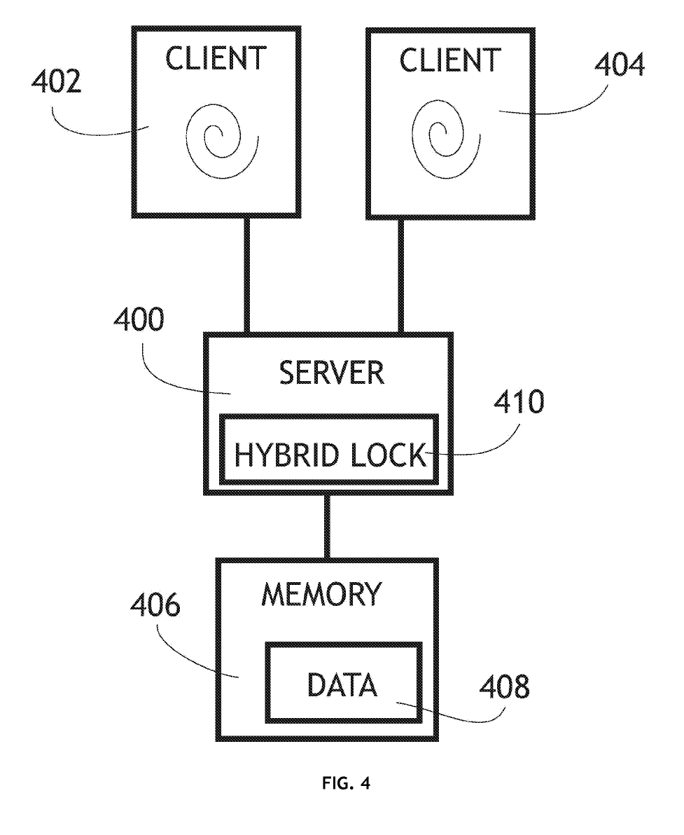

Referring to FIG. 4, an apparatus implementing the present method comprises a server 400 operatively connected to memory 406 containing data 408 controlled by a hybrid lock data structure 410, and at least two clients executing independent execution threads 402 and 404 operatively connected to the server. In this embodiment, computer executable code executing on the server 400 provides access to the data 408 stored in the memory 406. The computer executable code providing access to the data also limits access to the data in a client-server environment by means of a hybrid lock data structure 410. A client 402 or 404 requesting access to the data 408 to perform a read operation must provide an indication of the intensity of the intended read operation. Where the client 402 or 404 indicates a heavy intensity read operation, the computer executable code grants the client 402 or 404 a low contention cost lock through the hybrid lock data structure 410. Where the client 402 or 404 indicates a low intensity read operation, the computer executable code grants the client 402 or 404 a low overhead cost lock through the hybrid lock data structure 410.

The user may supply an indication of intensity at the time the user requests access to the data. For example, in an implementation providing user access to a database, the user may submit a query along with the user's assessment of the intensity of the read operation.

A computer system implementing the present method may determine the intensity of a read operation algorithmically. For example, computer executable code implementing the present method may contain logic to categorize a read operation requesting all rows in a table or results from several merged tables as a heavy intensity read operation.

The present method may define certain operations as either heavy intensity or low intensity within the computer code at the time of compilation even though the software developer has no foreknowledge of when or if such operations will actually be performed. By this method, control over the lock scheme may be achieved during execution of the computer executable code while optimizing the lock structure for otherwise unpredictable applications of the computer executable code.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An apparatus for maintaining data synchronization in a multi-threaded environment, comprising:
at least one processing unit;
memory functionally connected to the at least one processing unit, configured to contain a data set; and
computer executable program code executing on the at least one processing unit, configured to control and limit access to the data set contained in the memory through a hybrid lock data structure, and configured to implement different types of locks based on an indication of intensity of a read operation

2. The apparatus of claim 1 wherein the computer executable program code is further configured to implement a low contention cost lock on a dataset contained in the memory when the computer executable program code receives an indication that a read operation is a heavy intensity read operation, and configured to implement a low overhead cost lock on a dataset contained in the memory when the computer executable program code receives an indication that a read operation is a low intensity read operation

3. The apparatus of claim 2 wherein the computer executable program code is further configured to implement a spin lock on a data set contained in the memory when the computer executable program code receives an indication that a read operation is a low intensity read operation.

4. The apparatus of claim 2 wherein the computer executable program code is further configured to implement semaphores on a data set contained in the memory when the computer executable program code receives an indication that a read operation is a heavy intensity read operation.

5. The apparatus of claim 1 further comprising a plurality of execution threads executing on the at least one processing unit configured to request access to a data set contained in the memory through a hybrid lock data structure.

6. The apparatus of claim 5 wherein at least one of the plurality of execution threads is configured to provide an indication of the intensity of a read operation to the computer executable program code.

7. The apparatus of claim 6 wherein the computer executable program code is further configured to implement a low contention cost lock on a dataset contained in the memory when the computer executable program code receives an indication from one of the plurality of execution threads that a read operation is a heavy intensity read operation, and configured to implement a low overhead cost lock on a dataset contained in the memory when the computer executable program code receives an indication from one of the plurality of execution threads that a read operation is a low intensity read operation

8. An apparatus for maintaining data synchronization in a client-server environment, comprising:
a server;
memory functionally connected to the server, configured to contain a data set; and
computer executable program code executing on the server, configured to control and limit access to a data set contained in the memory through a hybrid lock data structure, and configured to implement different types of locks based on an indication of intensity of a read operation provided to the computer executable program code.

9. The apparatus of claim 8 wherein the computer executable program code is further configured to implement a low contention cost lock on a dataset contained in the memory when the computer executable program code receives an indication that a read operation is a heavy intensity read operation, and configured to implement a low overhead cost lock on a dataset contained in the memory when the computer executable program code receives an indication that a read operation is a low intensity read operation.

10. The apparatus of claim 9 wherein the computer executable program code is further configured to implement a spinlock on a data set contained in the memory when the computer executable program code receives an indication that a read operation is a low intensity read operation.

11. The apparatus of claim 9 wherein the computer executable program code is further configured to implement semaphores on a data set contained in the memory when the computer executable program code receives an indication that a read operation is a heavy intensity read operation.

12. The apparatus of claim 9 further comprising a plurality of execution threads, wherein at least one of the plurality of execution threads is configured to provide an indication of intensity of a read operation to the computer executable program code.

13. The apparatus of claim 8 further comprising a plurality clients functionally connected to the server, each client further configured to execute at least one execution thread, wherein each execution thread is configured to request access to a data set contained in the memory through a hybrid lock data structure.

14. The apparatus of claim 13 wherein the computer executable program code is further configured to implement a spinlock on a data set contained in the memory when the computer executable program code receives an indication from one of the plurality of clients that a read operation is a low intensity read operation.

15. The apparatus of claim 13 wherein the computer executable program code is further configured to implement semaphores on a data set contained in the memory when the computer executable program code receives an indication from one of the plurality of clients that a read operation is a heavy intensity read operation.

16. A method for synchronizing data comprising:
determining if a read operation is a heavy or low intensity read operation;
acquiring a lock on the data to be read;
performing a read operation on the locked data;
releasing the lock on the locked data,
wherein for low intensity read operations, the lock acquired on the data to be read is of a type specifically designed for low overhead cost, and for heavy intensity read operations, the lock acquired on the data to be read is of a type specifically designed for low contention cost.

17. The method of claim 16 wherein the lock acquired on the data to be read is exclusive.

18. The method of claim 16 wherein the lock acquired on the data to be read is a spinlock.

19. The method of claim 16 wherein the lock acquired on the data to be read is non-exclusive.

20. The method of claim 16 wherein the lock acquired is a semaphore.

21. The method of claim 16 further comprising determining if an operation is a read or write operation.

22. The method of claim 21 further comprising:
acquiring a low contention cost lock on data;
acquiring a low overhead cost lock on the locked data;
performing a write operation on the locked data;
releasing the low overhead cost lock on the locked data; and
releasing the low contention cost lock on the locked data,
wherein the operation to be performed is a write operation.
